(19) United States
(12) Patent Application Publication
(10) Pub. No.: US 2003/0044207 A1
(43) Pub. Date: Mar. 6, 2003

(54) Conductive fiber brush cleaner having separate zones

(75) Inventors: Kenneth J. Brown, Rochester, NY (US); George David Gross, Rochester, NY (US); Joseph A. Kwiatkowski, Rochester, NY (US); Francisco L. Ziegelmuller, Rochester, NY (US)

Correspondence Address: Lawrence P. Kessler, Patent Department, NexPress Solutions LLC, 1447 St. Paul Street, Rochester, NY, 14653-7103, US

(73) Assignee: NexPress Solutions LLC

(21) Appl. No.: 10/080,215

(22) Filed: Feb. 21, 2002

Related U.S. Application Data
(60) Provisional application No. 60/317,393, filed on Sep. 5, 2001.

(51) Int. Cl. G03G 21/00

(52) U.S. Cl. 399/353

(57) ABSTRACT

A method and structure for a conductive fur brush cleaner assembly for an image processing apparatus is disclosed. The cleaner assembly has a casing, a plurality of rotating components within the casing and a plurality of sealing devices that divide the casing into a scavenging zone and a detone zone. The sealing devices prevent airborne waste particles from traveling from the detone zone into the scavenging zone.

### BACKGROUND OF THE INVENTION

1. Field of the Invention

The present invention relates in general to a cleaning assembly for, an electrostatographic marking engine, and more particularly to a cleaning assembly which is separated into different zones to prevent airborne waste toner particles from migrating from the detone zone to the scavenging zone.

2. Description of the Related Art

In a typical commercial reproduction apparatus (electrostatographic copier/duplicators, printers, or the like), a latent image charge pattern is formed on a uniformly charged dielectric member. Pigmented marking particles are attracted to the latent image charge pattern to develop such images on the dielectric member. A receiver member is then brought into contact with the dielectric member. An electric field, such as provided by a corona charger or an electrically biased roller, is applied to transfer the marking particle developed image to the receiver member from the dielectric member. After transfer, the receiver member bearing the transferred image is separated from the dielectric member and transported away from the dielectric member to a fuser apparatus at a downstream location. There, the image is fixed to the receiver member by heat and/or pressure from the fuser apparatus to form a permanent reproduction thereon.

However, not all of the marking particles are transferred to the printing material and some remain upon the belts or drum. Therefore, a cleaning assembly is commonly used to remove the excess marking particles. The cleaning assembly usually includes an electrostatic cleaning brush, a (detoning roller), a skive, and a receptacle to hold the excess marking particles (waste toner material). The devices within the cleaner assembly generally rotate to remove waste particles.

However, a problem occurs when toner that is removed from the detone roller by the skive becomes airborne and is attracted back to the conductive fiber brush. This reduces the efficiency of the cleaner assembly because waste particles may have to be removed from the conductor fiber brush a number of times before it reaches the waste chamber. More importantly, it is also possible for such airborne waste toner particles to be carried outside the cleaner through the viscous boundary layer of air created due to the rotation of the cleaning brush. If this waste toner exits in the cleaning assembly, it can contaminate the outside surfaces of the cleaner and/or the remaining portions of the image processing apparatus. Therefore, there is a need to prevent waste toner particles that are removed from the detone roller from becoming airborne and re-entering the scavenging zone of the cleaner assembly. The invention discussed below addresses this problem by providing a solution that uses flaps or some similar device to divide the cleaner assembly into a scavenging zone and a detoning zone whereby, once the waste particles enter the detoning zone, they are prevented from re-entering the scavenging zone.

### SUMMARY OF THE INVENTION

In view of the foregoing and other problems, disadvantages, and drawbacks of the conventional cleaner assembly, the present invention has been devised, and it is an object of the present invention, to provide a structure and method for an improved cleaner assembly.

In order to attain the object suggested above, there is provided, according to one aspect of the invention a conductive fur brush cleaner assembly for an image processing apparatus. The cleaner assembly includes a casing, a plurality of rotating components within the casing, and a plurality of sealing devices that divide the casing into a scavenging zone and a detone zone. The sealing devices prevent airborne waste particles from traveling from the detone zone into the scavenging zone. The rotating components include a detone roller in contact with at least one of the sealing devices. The cleaner sealing devices can comprise a plush fabric seal or a flap. The sealing devices have sufficient rigidity to maintain contact with the rotating components while the rotating components are rotating. The sealing devices can be air curtains, flaps, and/or plush fabric seals.

The invention also includes a method of controlling airborne waste particles in a conductive fur brush cleaner assembly for an image processing apparatus. The method comprises producing rotating components within a casing, and dividing the casing into a scavenging zone and a detone zone using sealing devices. The sealing devices prevent the airborne waste particles from traveling from the detone zone into the scavenging zone.

Thus, the invention physically separates the cleaning apparatus into a scavenging zone and a detoning zone using, for example, flaps or plushes. Such physically separated zones reduce the volume of waste toner particles from the scavenging zone to increase the cleaning efficiency of the operating elements in the scavenging zone. By providing physical structures that create zones, the invention is superior to conventional structures and contains waste toner particles within the detoning zone, thereby reducing waste toner contamination of the cleaning (detoning) elements of the cleaning apparatus.

### BRIEF DESCRIPTION OF THE DRAWINGS

The foregoing and other objects, aspects and advantages will be better understood from the following detailed description of the preferred embodiments of the invention with reference to the drawings, in which:

FIGS. 1A and 1B are side elevation schematics of a color printer apparatus utilizing a cleaning apparatus of the invention.

FIG. 2 is a side elevation schematic showing in greater detail the cleaning apparatus forming a part of the apparatus of FIG. 1.

FIG. 3 is a side elevation schematic showing in greater detail the inventive flaps within the cleaning apparatus of FIG. 2.

### DETAILED DESCRIPTION OF PREFERRED EMBODIMENTS OF THE INVENTION

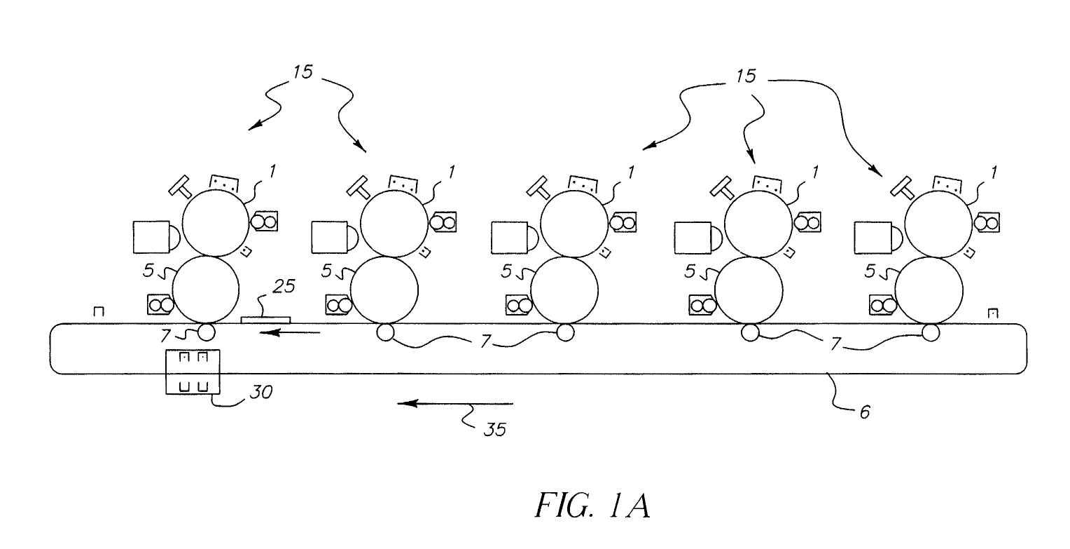

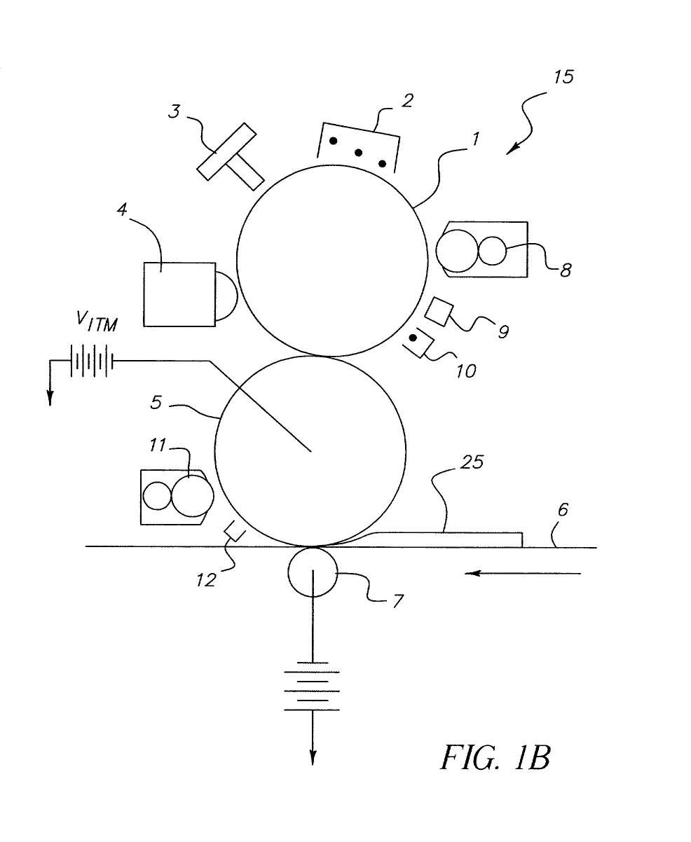

FIG. 1A illustrates an apparatus in which the invention may be used. A conveyor 6 is drivable to move a receiving sheet 25 (e.g., paper, plastic, etc.) past a series of stations 15. One of the stations 15 is shown in greater detail in FIG. 1B.

With the invention, a primary image member (for example, a photoconductive drum) 1 within each imaging station 15 is initially charged by a primary charging station 2. This charge is then modified by a printhead 3 (e.g., LED printhead) to create an electrostatic image on the primary image member 1. A development station 4 deposits toner on the primary image member 1 to form a toner image corresponding to the color toner in each individual imaging station 15. The toner image is electrostatically transferred from the primary image member 1 to an intermediate transfer member, for example, intermediate transfer roller or drum 5. While both of the primary image member 1 and the intermediate transfer drum 5 are shown as drums, as would be known by one ordinarily skilled in the art, these could also comprise belts or similar image transfer surfaces. The primary image member 1 and the intermediate transfer drum 5 are used in these examples to simplify the explanation of the invention; however, the invention is not limited to drums, but instead, is applicable to all similar structures/surfaces.

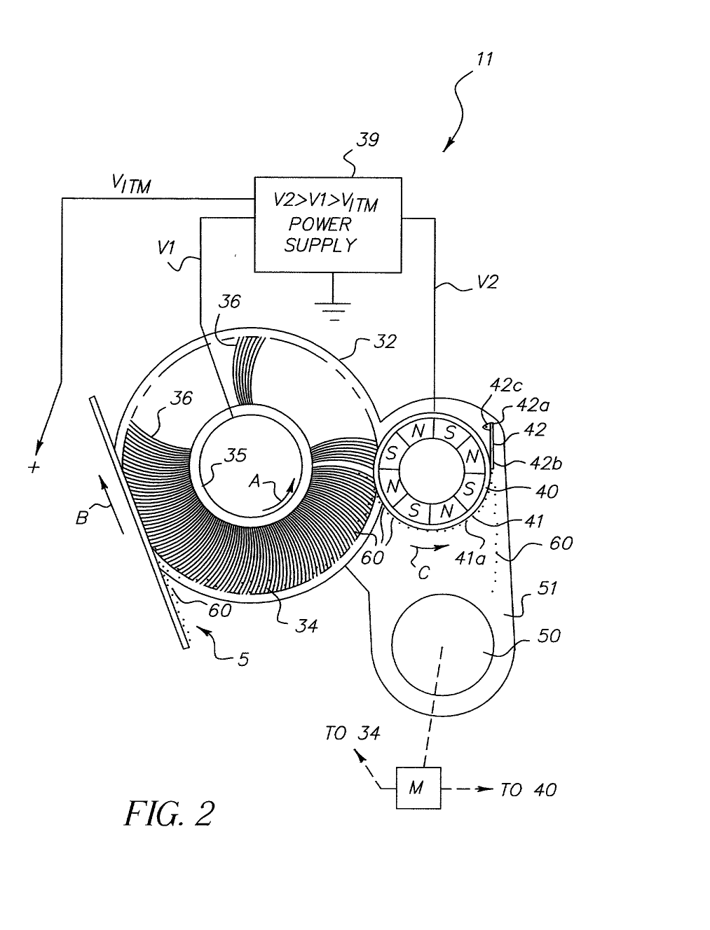

After the charged toner is transferred to the intermediate transfer drum 5, there still remains some waste toner particles that need to be removed from the primary image member 1. The invention uses a pre-cleaning erase light emitting diode (LED) lamp 9 in combination with pre-cleaning charging station 10 in order to electrostatically modify the surface potential of the non-image areas of the primary image member 1 and the charge on the waste toner remaining on the primary image member 1, respectively. In addition, a cleaning station 8 is included to physically remove any remaining waste toner particles. The cleaning station 8 is illustrated in FIG. 2 and is discussed in greater detail below.

A transfer nip is used between a transfer backer roller 7 and the intermediate transfer drum 5 to transfer the toner image to the receiving sheet 25. In a similar manner to that discussed above, the remaining waste toner particles that remain on the intermediate transfer drum 5 after the toner has been transferred to the sheet 25 are removed using a pre-cleaning charging station 12 and a cleaning station 11. Once again, the details of the cleaning station 11 are shown in FIG. 2 and are discussed below in detail. The receiving sheet 25 is transported by a dielectric conveyor 6 to a fuser 30 where the toner image is fixed by conventional means. The receiving sheet is then conveyed from the fuser 30 to an output tray 35.

The toner image is transferred from the primary image member 1 to the intermediate transfer drum 5 in response to an electric field applied between the core of drum 5 and a conductive electrode forming a part of primary image member 1. The toner image is transferred to the receiving sheet 25 at the nip in response to an electric field created between the backing roller 7 and the transfer drum 5. Thus, transfer drum 5 helps establish both electric fields. As is known in the art, a polyurethane roller containing an appropriate amount of anti-static material to make it of at least intermediate electrical conductivity can be used for establishing both fields. Typically, the polyurethane or other elastomer is a relatively thick layer; e.g., one-quarter inch thick, which has been formed on an aluminum base.

Preferably, the electrode buried in the primary image member 1 is grounded for convenience in cooperating with the other stations in forming the electrostatic and toner images. If the toner is a positively-charged toner, an electrical bias V_{ITM} applied to intermediate transfer drum 5 of typically −300 to −1,500 volts will effect substantial transfer of toner images to the transfer drum 2. To then transfer the toner image onto a receiving sheet 25, a bias, e.g., of −2,000 volts or greater negative voltages, is applied to backing roller 7 to again urge the positively-charged toner to transfer to the receiving sheet. Schemes are also known in the art for changing the bias on drum 5 between the two transfer locations so that roller 7 need not be at such a high potential.

The ITM or drum 5 has a polyurethane base layer upon which a thin skin is coated or otherwise formed having the desired release characteristics. The polyurethane base layer preferably is supported upon an aluminum core. The thin skin may be a thermoplastic and should be relatively hard, preferably having a Young's modulus in excess of 5*10⁷ Newtons per square meter to facilitate release of the toner to ordinary paper or another type of receiving sheet. The base layer is preferably compliant and has a Young's modulus of 10⁷ Newtons per square meter or less to assure good compliance for each transfer.

With reference also now to FIG. 2, the cleaning apparatus 11 comprises a housing 32 which encloses the cleaning brush 34 having conductive fibers (fur) 36 which, through an opening in the housing, engage the ITM 5.

The brush 34 is supported on a core 35 which is driven in rotation by a motor M or other motive source to rotate in the direction of the arrow A as the ITM is moved in the direction shown by arrow B. As the brush rotates, untransferred toner particles 60 and other particulate debris, such as carrier particles and paper dust on the ITM 5, are mechanically scrubbed from the ITM and picked up into the fibers 36 of the brush. The items illustrated in the figures are generally not shown to scale to facilitate understanding of the structure and operation of the apparatus. In particular, the brush fibers are shown much larger to scale than other structures shown in FIG. 2.

In addition to mechanical scrubbing, an electrical bias is applied to the cleaning brush from power supply 39. The electrical bias V1 of the power supply 39 to the cleaning brush is, as will be more fully explained below, inductively, and not conductively, coupled to the conductive fibers or brush fibers 36. The voltage V1 is greater than the voltage bias V_{ITM} applied to the ITM. The polarity of the voltage on the brush fibers is such as to electrostatically attract toner 60 to the brush fibers. The toner particles 60 entrained within the fibers are carried to a rotating detoning roller 40 which is electrically biased by power supply 39 to a higher voltage level V2 than the voltage level V1; i.e., the voltage level V2 is of a level to electrostatically attract the toner particles in the brush to the detoning roller. Assuming a positively-charged toner image, as an example, the toner image may be attracted to the ITM which is biased to the voltage bias V_{ITM} in the range of about −300 volts to about −1500 volts. The cleaning brush, in such an example, would be biased to a potential V1 which is in the range of about −550 volts to about −1750 volts. The detoning roller in this example would be biased to a potential V2 which is in the range of about −800 volts to about −2000 volts. In considering relationships of voltage V2>V1>V_{ITM}, the absolute values of the voltages are implied.

The toner particles 60 are electrostatically attracted to the surface 41 of the detoning roller 40. The surface of detoning roller 40 is rotated in the direction of arrow C by a drive from motor M counter to that of the brush fibers or alternatively in the same direction. The toner particles are carried by the surface 41 of the detoning roller toward a stationary skive blade 42 which is supported as a cantilever at end 42a so that the scraping end 42b of the blade 42 engages the surface 41 of the detoning roller.

Toner particles scrubbed from the surface are allowed to fall into a collection chamber 51 of housing 32 and periodically a drive, such as from motor M or another motive source, is provided to cause an auger 50 or other toner transport device to feed the toner to a waste receptacle. Alternatively, the collection receptacle may be provided, attached to housing 32, so that particles fall into the receptacle directly and the auger may be eliminated. In order to ensure intimate contact between the detoning roller surface 41 and the skive blade 42, a permanent magnet is stationarily supported within the hollow enclosure of the detoning roller.

The skive blade is made of a metal such as ferromagnetic steel and is of a thickness of less than 0.5 mm and is magnetically attracted by the magnet to the detoning roller surface 41. This effectively minimizes the tendency of the blade end 42b to chatter as the surface 41 travels past the blade end 42b and thus provides more reliable skiving of the toner and, therefore, provides improved image reproduction. The skive blade extends for the full working width of the detoning roller surface 41 and is supported at its end 42b by ears 42c which are soldered to the blade. A pin extends through a hole in the ear portion to connect the skive to the housing.

The detoning roller 40 preferably comprises a toning or development roller as is used in known SPD-type development stations which include a core of permanent magnets surrounded by a metal sleeve 41a. As a detoning roller, the magnetic core is formed of a series of alternately arranged poles (north-south-north-south, etc.), permanent magnets 41b that are stationary when in operation. Sleeve 41a is formed of polished aluminum or stainless steel and is electrically conductive, but nonmagnetic, so as to not reduce the magnetic attraction of the skive blade to the magnets in the core. The sleeve is driven in rotation in the direction of arrow C and is electrically connected to potential V2.

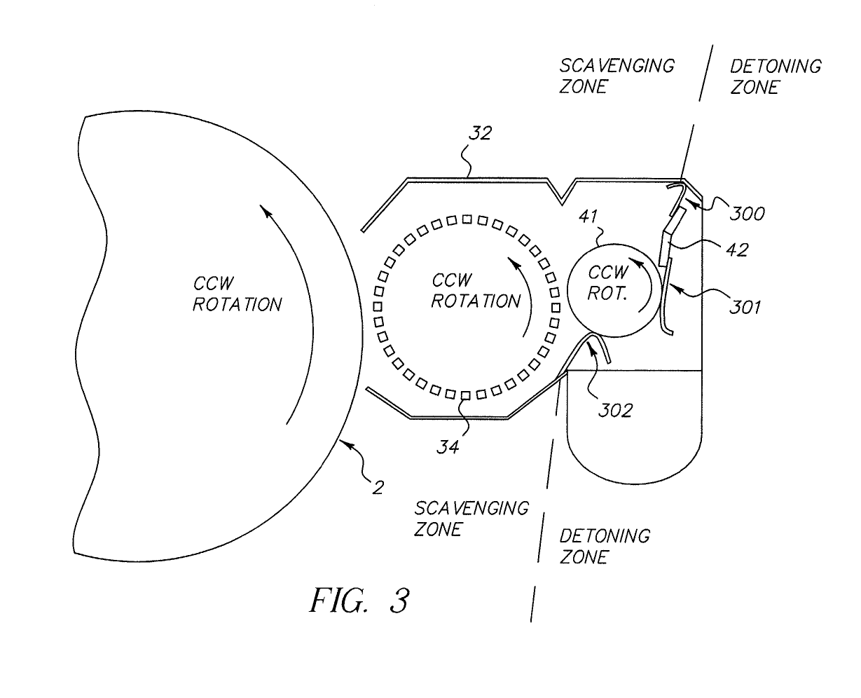

FIG. 3 illustrates the cleaner assembly shown in FIG. 2 in greater detail. As discussed above, toner that is removed from the detone roller by the skive becomes airborne and can be attracted back to the conductive fiber brush. This reduces the efficiency of the cleaner assembly because waste particles may have to be removed from the conductive fiber brush a number of times before they reach the waste chamber. More importantly, it is also possible for such airborne waste toner particles to be carried outside the cleaner through the viscous boundary layer of air created by the rotation of the cleaning brush. If this waste toner exits the cleaning assembly, it can contaminate the remaining portions of the image processing apparatus. The inventive cleaner assembly shown in FIG. 3 prevents waste toner particles that are removed from the detoner roller from becoming airborne and re-entering the scavenging zone of the cleaner assembly. More specifically, the invention addresses this problem by providing a solution that uses flaps 300-302 to divide the cleaner assembly into a scavenging zone and a detoning zone (as conceptually illustrated by the dashed line crossing FIG. 3) whereby, once the waste particles enter the detoning zone, they are prevented from re-entering the scavenging zone.

FIG. 3 illustrates an upper skive flap 300 that is connected between the top of the skive 42 and the outer casing 32. Additionally, the skive 42 includes a lower skive flap 301 that is rigidly attached to the skive 42 and is biased against the detone roller 41. More specifically, the lower skive flap 301 has sufficient rigidity that it is held against the detone roller 41. In addition, a bottom flap 302 is connected to the lower part of the casing 32 and is biased against the detone roller 41. Each of the flaps 300-302 includes additional material at the ends of the flaps which is curved and extends into the detoning zone. This additional material insures that the flaps 300-302 will continue to make contact with the movable elements (detone roller 41, skive 42, etc.) even if there are large size and position variations of the casing 32, skive 42, detone roller 41, etc., caused by manufacturing variations. These flaps can be constructed out of a non-conductive polymeric material such as Mylar® (DuPont High Performance Materials, P.O. Box 89, Route 23 South and DuPont Road, Circleville, Ohio 43113), plush fabric, air curtains, etc., anywhere from “0.001 to 0.003” thick and attached to the casing of the cleaner or skive blade with an adhesive backing on the flap. The flap 302 needs to be of sufficient flexibility to allow waste material to pass into the detoning zone from the scavenging zone.

While the invention illustrates two flaps 300-302, the invention is not limited to the specific structure shown in FIG. 3. To the contrary, the invention could include more or fewer flaps, depending upon the specific shape of the various components within the cleaner apparatus. Also, the invention is not limited to the use of flaps, but could also make use of fabric plush material to effect the proper sealing between the scavenging and detoning zones. Indeed, the invention is applicable to all such cleaner apparatus that need to control airborne waste particles. Thus, the invention is not limited to the specific embodiments described herein, but is applicable to all structures that utilize flaps or plushes within the cleaner assembly to control airborne waste particles.

The invention physically separates the cleaning apparatus into a scavenging zone and a detoning zone using, for example, flaps or plushes. Such physically separated zones reduce the volume of waste toner particles from the scavenging zone to increase the cleaning, efficiency of the operating elements in the scavenging zone. By providing physical structures that create zones, the invention is superior to conventional structures and contains waste toner particles within the detoning zone, thereby reducing waste toner contamination of the cleaning (detoning) elements of the cleaning apparatus.

While the invention has been described in terms of preferred embodiments, those skilled in the art will recognize that the invention can be practiced with modification within the spirit and scope of the appended claims.

### PARTS LIST

Item Description

1 image member

2 imaging charging station

3 printhead

4 development station

5 drum

6 conveyor

7 transfer backer roller

8 cleaning station

9 LED lamp

10 pre-cleaning charging station

11 cleaning station

12 pre-cleaning charging station.

15 station

25 receiving sheet

30 fuser

32 casing/housing

34 cleaning brush

35 output tray

36 fibers

39 power supply

40 detoning roller

41 surface

41a sleeve

41b permanent magnets

42 skive blade

42a blade end

42b scraping blade end

42c blade ears

50 auger

51 collection chamber

60 toner particles

300 upper skive flap

301 lower skive flap

302 bottom skive flap

What is claimed is:

1. A conductive fur brush cleaner assembly for an image processing apparatus, said cleaner assembly comprising:
a casing;
a plurality of rotating components within said casing; and
a plurality of sealing devices that divide said casing into a scavenging zone and a detone zone,
wherein said sealing devices prevent airborne waste particles from traveling from said detone zone into said scavenging zone.

2. The cleaner assembly in claim 1, wherein said rotating components include a detone roller and at least one of said sealing devices contacts said detone roller.

3. The cleaner assembly in claim 1, wherein at least one of said sealing devices comprises a flap.

4. The cleaner assembly in claim 1, wherein at least one of said sealing devices comprises a plush fabric seal.

5. The cleaner assembly in claim 1, wherein said sealing devices have sufficient rigidity to maintain contact with said rotating components while said rotating components are rotating.

6. The cleaner assembly in claim 1, wherein said sealing devices are selected from one of the following: air curtains, flaps, and plush fabric seals.

7. The cleaner assembly in claim 6, wherein said sealing devices additionally employ another from the list of: air curtains, flaps, and plush fabric seals.

8. A conductive fur brush cleaner assembly for an image processing apparatus, said cleaner assembly comprising:
a casing;
a plurality of rotating components within said casing; and
a plurality of sealing flaps connected to said casing that divide said casing into a scavenging zone and. a detone zone,
wherein said sealing flaps prevent airborne waste particles from traveling from said detone zone into said scavenging zone.

9. The cleaner assembly in claim 8, wherein said rotating components include a detone roller and at least one of said sealing flaps contacts said detone roller.

10. The cleaner assembly in claim 8, wherein said sealing flaps comprise a non-conductive polymeric material.

11. The cleaner assembly in claim 8, wherein at least one of said sealing flaps includes a plush fabric seal.

12. The cleaner assembly in claim 8, wherein said sealing flaps have sufficient rigidity to maintain contact with said rotating components while said rotating components are rotating.

13. The cleaner assembly in claim 8, wherein said sealing flaps include a curved end portion that extends into said detone zone, wherein said curved portion is adapted to rebound said airborne waste particles toward said detone zone.

14. The cleaner assembly in claim 8, wherein said rotating components include a detone roller and said flaps include a bottom flap attached to a lower portion of said casing, wherein said bottom flap includes sufficient rigidity to maintain contact with said detone roller when said detone roller is rotating.

15. The cleaner assembly in claim 14, further comprising a skive blade attached to said casing, wherein said skive blade contacts said detone roller and is adapted to remove waste toner particles from said detone roller,
wherein said sealing flaps include an upper skive flap connected to an upper portion of said casing and to an upper portion of said skive blade.

16. The cleaner assembly in claim 15, wherein said sealing flaps include a lower skive flap connected to a lower portion of said skive blade, and wherein said lower skive flap includes sufficient rigidity to maintain contact with said detone roller when said detone roller is rotating.

17. A method of controlling airborne waste particles in a conductive fur brush cleaner assembly for an image processing apparatus, said method comprising:
providing a plurality of rotating components within a casing;
dividing said casing into a scavenging zone and a detone zone using a plurality of sealing devices,
wherein said sealing devices prevent said airborne waste particles from traveling from said detone zone into said scavenging zone.

18. The method in claim 17, wherein said rotating components include a detone roller and said dividing process positions at least one of said sealing devices to contact said detone roller.

19. The method in claim 17, wherein at least one of said sealing devices comprises a flap.

20. The method in claim 17, wherein at least one of said sealing devices comprises a plush fabric seal.

21. The method in claim 17, wherein said sealing devices have sufficient rigidity to maintain contact with said rotating components while said rotating components are rotating.

22. The method in claim 17, wherein said sealing devices are selected from one of the following: air curtains, flaps, and plush fabric seals.

23. The method in claim 22, wherein said sealing devices additionally employ another from the list of: air curtains, flaps, and plush fabric seals.

24. A method of controlling airborne waste particles in a conductive fur brush cleaner assembly for an image processing apparatus, said method comprising:
providing a plurality of rotating components within a casing;
dividing said casing into a scavenging zone and a detone zone using a plurality of sealing flaps connected to said casing,
wherein said sealing flaps prevent airborne waste particles from traveling from said detone zone into said scavenging zone.

25. The method in claim 24, wherein said rotating components include a detone roller and said dividing positions at least one of said sealing flaps to contact said detone roller.

26. The method in claim 24, wherein said sealing flaps comprise a non-conductive polymeric material.

27. The method in claim 24, wherein at least one of said sealing flaps includes a plush fabric seal.

28. The method in claim 24, wherein said sealing flaps have sufficient rigidity to maintain contact with said rotating components while said rotating components are rotating.

29. The method in claim 24, wherein said dividing selects said sealing flaps to include a curved end portion that extends into said detone zone, wherein said curved portion is adapted to rebound said airborne waste particles toward said detone zone.

30. The method in claim 24, wherein said rotating components include a detone roller and said dividing selects said sealing flaps to include a bottom flap attached to a lower portion of said casing, wherein said bottom flap includes sufficient rigidity to maintain contact with said detone roller when said detone roller is rotating.

31. The method in claim 24, wherein said providing further comprises providing a skive blade attached to said casing, wherein said skive blade contacts said detone roller and is adapted to remove waste toner particles from said detone roller, and
wherein said dividing selects said sealing flaps to include an upper skive flap connected to an upper portion of said casing and to an tipper portion of said skive blade.

32. The method in claim 24, wherein said dividing selects said sealing flaps to a lower skive flap connected to a lower portion of said skive blade, wherein said lower skive flap includes sufficient rigidity to maintain contact with said detone roller when said detone roller is rotating.
